(19) United States
(12) Patent Application Publication
(10) Pub. No.: US 2022/0301130 A1
(43) Pub. Date: Sep. 22, 2022

(54) IMAGE PROCESSING DEVICE, TELEPRESENCE SYSTEM, IMAGE PROCESSING METHOD, AND IMAGE PROCESSING PROGRAM

(71) Applicant: TOYOTA JIDOSHA KABUSHIKI KAISHA, Toyota-shi (JP)

(72) Inventors: Yusuke KIDA, Shinagawa-ku (JP); Takahiro NAKAYAMA, Koto-ku (JP)

(73) Assignee: TOYOTA JIDOSHA KABUSHIKI KAISHA, Toyota-shi (JP)

(21) Appl. No.: 17/655,426

(22) Filed: Mar. 18, 2022

(30) Foreign Application Priority Data
Mar. 22, 2021 (JP) 2021-046730

(51) Int. Cl. G06T 5/50; G06V 10/25; G06V 10/80; B25J 11/00

(52) U.S. Cl. CPC G06T 5/50; G06V 10/25; G06V 10/806; B25J 11/0005; G06T 2207/20212

(57) ABSTRACT

An image processing device according to an embodiment of the present disclosure is an image processing device that processes an image to be displayed on a display unit of a telepresence robot disposed at a first base. The image processing device includes a background image acquisition unit that acquires, in real time, image information obtained by capturing an image in a rear direction of the display unit, a person image acquisition unit that acquires, in real time, image information including a person at a second base that is a remote area from the first base, an extraction unit that extracts an area in which the person is displayed from the image information including the person, and a composition unit that combines the extracted image information on the person and the image information in the rear direction of the display unit.

### CROSS-REFERENCE TO RELATED APPLICATION

This application claims priority to Japanese Patent Application No. 2021-046730 filed on Mar. 22, 2021, incorporated herein by reference in its entirety.

### BACKGROUND

### 1. Technical Field

The present disclosure relates to an image processing device, a telepresence system, an image processing method, and an image processing program, and for example, relates to an image processing device, a telepresence system, an image processing method, and an image processing program for processing an image to be displayed on a display unit of a telepresence robot.

### 2. Description of Related Art

In recent years, telepresence technology has been generalized in which dialogue between one person and the other person is realized to make the one person feel as if the other person were at a place where the one person is even though the other person is in a remote place.

In such a telepresence technology, for example, as disclosed in Japanese Unexamined Patent Application Publication No. 2016-208416 (JP 2016-208416 A), an image including a person at a second base that is a remote area from a first base is displayed on a display unit of a telepresence robot disposed in the first base, and a virtual environment as if the person at the second base were at the first base is realized.

### SUMMARY

The applicant has found the following issues. The telepresence technology according to JP 2016-208416 A displays an image in which the person at the second base and a background of the person are displayed on the display unit of the telepresence robot. Therefore, in the virtual environment as if the person at the second base were at the first base, there is an issue that this telepresence technology does not give feeling of being present at the same location.

The present disclosure has been made in view of such problems, and realizes an image processing device, a telepresence system, an image processing method, and an image processing program that can enhance feeling of being present at the same location in a virtual environment as if the person at the second base were at the first base.

An image processing device according to one aspect of the present disclosure is an image processing device that processes an image to be displayed on a display unit of a telepresence robot disposed at a first base. The image processing device includes a background image acquisition unit that acquires, in real time, image information obtained by capturing an image in a rear direction of the display unit, a person image acquisition unit that acquires, in real time, image information including a person at a second base that is a remote area from the first base, an extraction unit that extracts an area in which the person is displayed from the image information including the person, and a composition unit that combines the extracted image information on the person and the image information in the rear direction of the display unit.

A telepresence system according to one aspect of the present disclosure includes the image processing device described above, a person imaging unit that captures an area including a person at a second base, a telepresence robot provided with a display unit, and a background imaging unit that captures an image in a rear direction of the display unit.

The telepresence system described above further preferably includes a first display unit as the display unit, and a second display unit that displays an image in a direction different from a direction of the first display unit.

The telepresence system described above further preferably includes a first imaging unit that captures an image in a rear direction of the first display unit as the background imaging unit, and a second imaging unit that captures an image in a rear direction of the second display unit.

The telepresence system described above further preferably includes a 360-degree camera as the background imaging unit.

An image processing method according to one aspect of the present disclosure is an image processing method that processes an image to be displayed on a display unit of a telepresence robot disposed at a first base. The image processing method includes a step of acquiring, in real time, image information obtained by capturing an image in a rear direction of the display unit, a step of acquiring, in real time, image information including a person at a second base that is a remote area from the first base, a step of extracting an area in which the person is displayed from the image information including the person, and a step of combining the extracted image information on the person and the image information in the rear direction of the display unit.

An image processing program according to one aspect of the present disclosure is an image processing program that processes an image to be displayed on a display unit of a telepresence robot disposed at a first base. The image processing program causes a computer to execute a process of acquiring, in real time, image information obtained by capturing an image in a rear direction of the display unit, a process of acquiring, in real time, image information including a person at a second base that is a remote area from the first base, a process of extracting an area in which the person is displayed from the image information including the person, and a process of combining the extracted image information on the person and the image information in the rear direction of the display unit.

According to the present disclosure, it is possible to realize an image processing device, a telepresence system, an image processing method, and an image processing program that can enhance feeling of being present at the same location in a virtual environment as if a person located at a second base were at a first base.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a state in which an image is displayed on a display unit of a telepresence robot using a telepresence system according to a first embodiment;

FIG. 2 is a block diagram showing a control system of the telepresence system according to the first embodiment;

FIG. 3 is a flowchart showing a flow of image processing to be executed by an image processing device according to the first embodiment;

FIG. 4 is a block diagram showing a control system of a telepresence system according to a second embodiment;

FIG. 5 is a front perspective view showing a telepresence robot according to the second embodiment;

FIG. 6 is a rear perspective view showing the telepresence robot according to the second embodiment;

FIG. 7 is a block diagram showing a control system of a telepresence system according to a third embodiment;

FIG. 8 is a front perspective view showing a telepresence robot according to the third embodiment; and

FIG. 9 is a diagram showing an example of a hardware configuration included in an image processing device.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, in order to clarify the explanation, the following description and drawings have been simplified as appropriate.

### First Embodiment

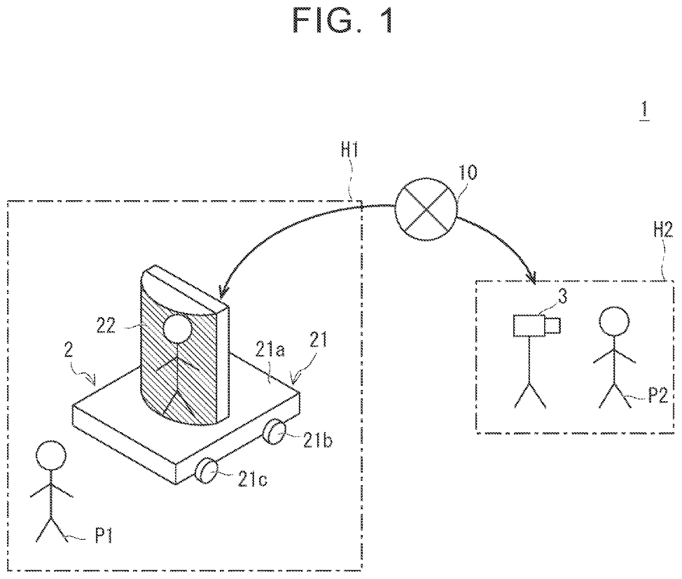

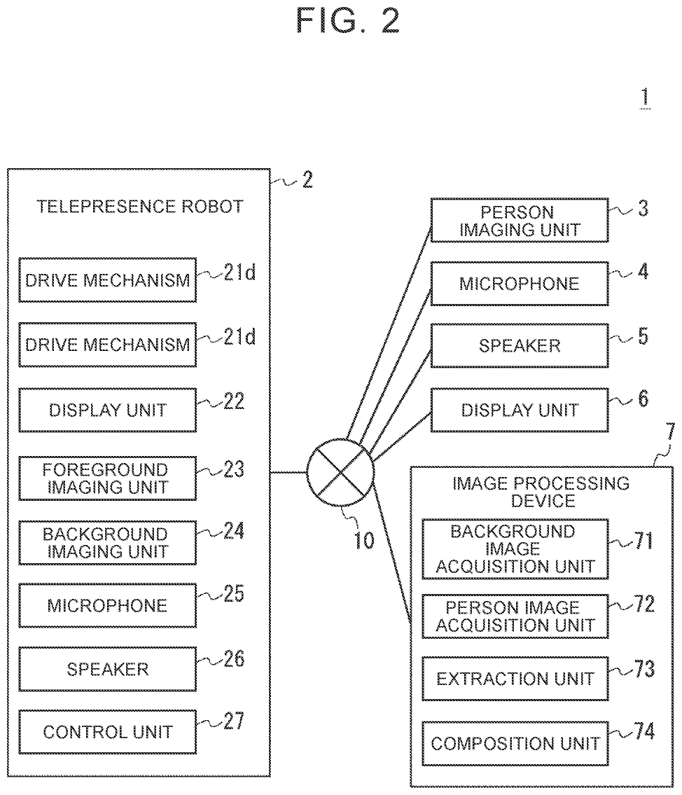

FIG. 1 is a diagram showing a state in which an image is displayed on a display unit of a telepresence robot using a telepresence system according to an embodiment. FIG. 2 is a block diagram showing a control system of the telepresence system according to the embodiment.

As shown in FIGS. 1 and 2, a telepresence system 1 according to the embodiment includes a telepresence robot 2, a person imaging unit 3, a microphone 4, a speaker 5, a display unit 6, and an image processing device 7.

As shown in FIG. 1, the telepresence robot 2 is located at a first base H1 and is connected to a network 10. Here, the network 10 is, for example, the Internet, and is constructed of a telephone line network, a wireless communication path, Ethernet (registered trademark), and the like.

As shown in FIGS. 1 and 2, the telepresence robot 2 includes a moving unit 21, a display unit 22, a foreground imaging unit 23, a background imaging unit 24, a microphone 25, a speaker 26, and a control unit 27. The moving unit 21 includes a carriage 21a, a pair of drive wheels 21b and a pair of driven wheels 21c that are rotatably provided on the carriage 21a, and a pair of drive mechanisms 21d that drives the drive wheels 21b such that the drive wheels 21b rotate.

The drive mechanism 21d includes a motor, a speed reducer, and the like. The drive mechanism 21d drives the drive wheels 21b based on control information received from the control unit 27 to rotate the drive wheels 21b, thereby enabling the telepresence robot 2 to move forward, move backward, and rotate.

As a result, the telepresence robot 2 can move to an appropriate position.

Here, for example, the telepresence robot 2 may autonomously move based on environmental information acquired by an environmental camera (not shown), move based on an operation from the outside, and move based on movement of a person P2 located at a second base H2 that is a remote area from the first base H1.

A configuration of the moving unit 21 is an example, and the present disclosure is not limited to this. For example, the numbers of the drive wheels 21b and the driven wheels 21c of the moving unit 21 may be set as appropriate, and a known mechanism can be used as long as the telepresence robot 2 can be moved to an appropriate position.

The display unit 22 includes a display device such as a liquid crystal display or an organic electroluminescence (EL) display. The display unit 22 displays a composite image of image information of the person P2 at the second base H2 and image information in a rear direction of the display unit 22. Here, in FIG. 1, an image in the rear direction of the display unit 22 is simplified and shown by hatching.

The display unit 22 is fixed to the moving unit 21 so as to be able to display an image toward the front of the telepresence robot 2. That is, a display surface of the display unit 22 is disposed so as to face the front of the telepresence robot 2.

At this time, the display surface of the display unit 22 may be a curved surface that projects toward the front of the telepresence robot 2. Further, the display unit 22 may have a size capable of displaying at least the upper body of the person P2 when the person P2 at the second base H2 is displayed in a substantially actual size, for example.

The foreground imaging unit 23 includes a camera including an image sensor such as Complementary Metal Oxide Semiconductor (CMOS). The foreground imaging unit 23 is fixed to the moving unit 21 so as to be able to capture an image in the front direction (that is, the image display direction) of the display unit 22 in real time. That is, the foreground imaging unit 23 sets the front area of the telepresence robot 2 as an imaging range. At this time, the foreground imaging unit 23 may be disposed in the vicinity of the display unit 22.

The background imaging unit 24 includes a camera including an image sensor such as CMOS. The background imaging unit 24 is fixed to the moving unit 21 so as to be able to capture an image in the rear direction (that is, an opposite direction to the image display direction) of the display unit 22 in real time. That is, the background imaging unit 24 sets the rear area of the telepresence robot 2 as an imaging range.

The microphone 25 collects sound inside the first base H1. The speaker 26 outputs sound inside the second base H2. The microphone 25 and the speaker 26 are provided in the moving unit 21. The microphone 25 and the speaker 26 may be disposed in the first base H1. The control unit 27 controls the drive mechanism 21d of the moving unit 21, the display unit 22, the foreground imaging unit 23, the background imaging unit 24, the microphone 25, and the speaker 26.

As shown in FIG. 1, the person imaging unit 3 is disposed in the second base H2 so as to be able to capture an image in the second base H2. Therefore, when the person P2 is located at an imaging area of the person imaging unit 3, the person imaging unit 3 captures an image including the person P2.

The microphone 4 is disposed in the second base H2. The microphone 4 collects sound inside the second base H2. The speaker 5 is disposed in the second base H2. The speaker 5 outputs sound inside the first base H1. The display unit 6 includes a display device such as a liquid crystal display or an organic EL display.

The display unit 6 is disposed in the second base H2, and displays an image in the front direction of the display unit 22 at the first base H1, the image being captured by the foreground imaging unit 23 of the telepresence robot 2. At this time, the display unit 6 may be disposed in the vicinity of the person imaging unit 3. The person imaging unit 3, the microphone 4, the speaker 5, and the display unit 6 are connected to the network 10.

As shown in FIG. 2, the image processing device 7 includes a background image acquisition unit 71, a person image acquisition unit 72, an extraction unit 73, and a composition unit 74, and is connected to the network 10. The background image acquisition unit 71 acquires image information in the rear direction of the display unit 22 in real time, the image being captured by the background imaging unit 24 of the telepresence robot 2. The background image acquisition unit 71 may acquire the image information in the rear direction of the display unit 22, and for example, may be provided with the background imaging unit 24.

The person image acquisition unit 72 acquires, in real time, image information that includes the person P2 at the second base H2 and that is captured by the person imaging unit 3. The person image acquisition unit 72 may acquire image information including the person P2 at the second base H2, and for example, may be provided with the person imaging unit 3.

The extraction unit 73 extracts an area in which the person P2 is displayed from the image information including the person P2 at the second base H2. The extraction unit 73 can extract the area in which the person P2 is displayed, for example, by performing chroma key processing on the image information including the person P2 at the second base H2. However, a method of extracting the area in which the person P2 is displayed from the image information including the person P2 at the second base H2 is not limited, and a known method can be used.

The composition unit 74 combines the extracted image information on the person P2 and the image information in the rear direction of the display unit 22. At this time, the composition unit 74 may combine the extracted image information on the person P2 and the image information in the rear direction of the display unit 22 such that the extracted image of the person P2 is disposed at a preset position with respect to the image in the rear direction of the display unit 22.

Here, the composition unit 74 can combine the extracted image information on the person P2 and the image information in the rear direction of the display unit 22 by, for example, by chroma key compositing, but a method of combining the mutual image information is not limited, and a known method can be used.

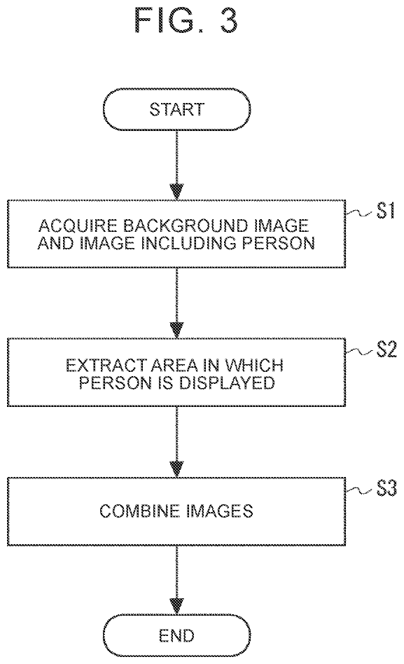

Next, a flow of image processing to be executed by the image processing device 7 according to the embodiment will be described. FIG. 3 is a flowchart showing the flow of image processing to be executed by the image processing device according to the embodiment.

First, the background image acquisition unit 71 acquires image information in the rear direction of the display unit 22 in real time, the image being captured by the background imaging unit 24 of the telepresence robot 2. At the same time, the person image acquisition unit 72 acquires, in real time, image information that includes the person P2 at the second base H2 and that is captured by the person imaging unit 3 (S1).

Next, the extraction unit 73 extracts an area in which the person P2 is displayed from the image information including the person P2 at the second base H2 (S2). Then, the composition unit 74 combines the extracted image information on the person P2 and the image information in the rear direction of the display unit 22 (S3). As a result, it is possible to generate a composite image of the extracted image information on the person P2 and the image information in the rear direction of the display unit 22.

Next, a state in which the person P1 at the first base H1 and the person P2 at the second base H2 are having a dialogue with each other using the telepresence system 1 according to the embodiment will be described. The person P2 at the second base H2 listens to the sound inside the first base H1 output from the speaker 5 while viewing an image including the person P1 at the first base H1 displayed on the display unit 6, moves in front of the display unit 6, and talks to the person P1 displayed on the display unit 6.

At this time, at the second base H2, an image including the person P2 at the second base H2 is captured by the person imaging unit 3, and the sound inside the second base H2 including the voice of the person P2 is collected by the microphone 4.

The person P1 at the first base H1 listens to the sound inside the second base H2 that is output from the speaker 26 and that includes the voice of the person P2 while viewing a composite image displayed on the display unit 22 of the telepresence robot 2, moves in front of the display unit 22, and talks to the person P2 displayed on the display unit 22.

At this time, at the first base H1, the foreground imaging unit 23 captures an image including the person P1 at the first base H1, and the background imaging unit 24 captures an image in the rear direction of the display unit 22. Further, the microphone 25 collects the sound inside the first base H1 including the voice of the person P1.

As a result, in a virtual environment as if the person P2 at the second base H2 were at the first base H1, the person P1 at the first base H1 and the person P2 at the second base H2 can have a dialogue with each other. At this time, the display unit 22 of the telepresence robot 2 displays a composite image in which the extracted image information on the person P2 and the image information in the rear direction of the display unit 22 are combined.

As described above, in the telepresence system 1, the image processing device 7, and the image processing method according to the embodiment, the display unit 22 of the telepresence robot 2 displays a composite image in which the extracted image information on the person P2 and the image information in the rear direction of the display unit 22 are combined.

Therefore, in a virtual environment as if the person P2 at the second base H2 were at the first base H1, the background of the person P2 in the composite image can be substantially equal to the background positioned in the line-of-sight direction of the person P1 at the first base H1, which gives enhanced feeling of being present at the same location.

Further, the image information in the rear direction of the display unit 22 of the telepresence robot 2 and the image information including the person P2 at the second base H2 are acquired in real time, which gives further enhanced feeling of being present at the same location.

Here, when the display surface of the display unit 22 of the telepresence robot 2 is a curved surface that protrudes toward the front of the telepresence robot 2, the person P2 is displayed in a rounded manner on the display surface, which gives further enhanced feeling of being present at the same location.

The display unit 22 of the telepresence robot 2 according to the embodiment is disposed so as to display an image toward the front of the telepresence robot 2, but a direction in which the display unit 22 displays the image is not limited, and for example, the direction in which the display unit 22 displays the image may be on the side of the telepresence robot 2 or behind the telepresence robot 2. In this case, the position in which the background imaging unit 24 is disposed may be appropriately changed according to the position in which the display unit 22 is disposed.

### Second Embodiment

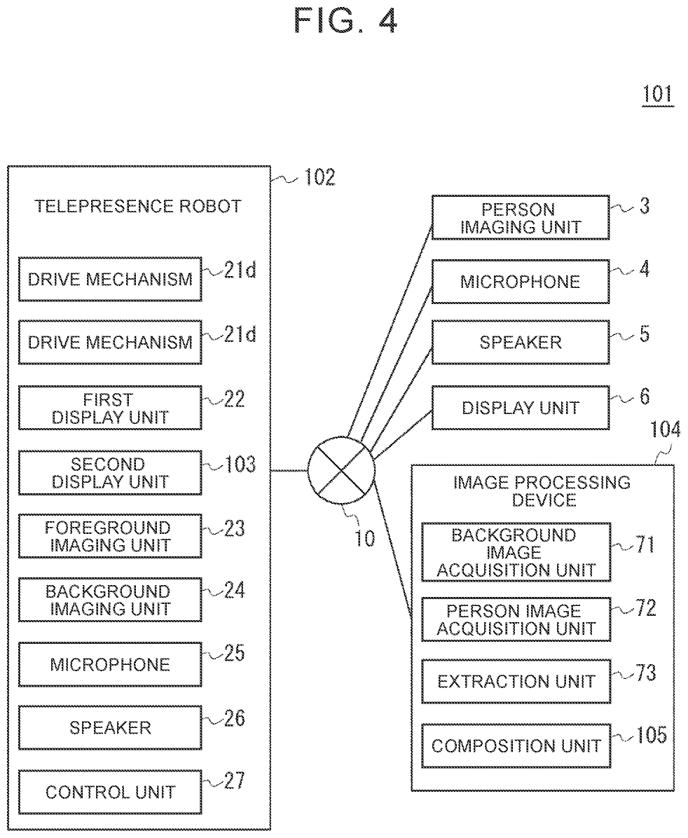

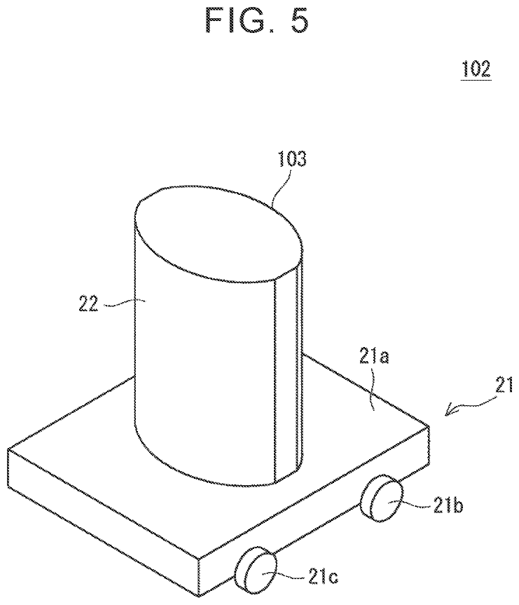

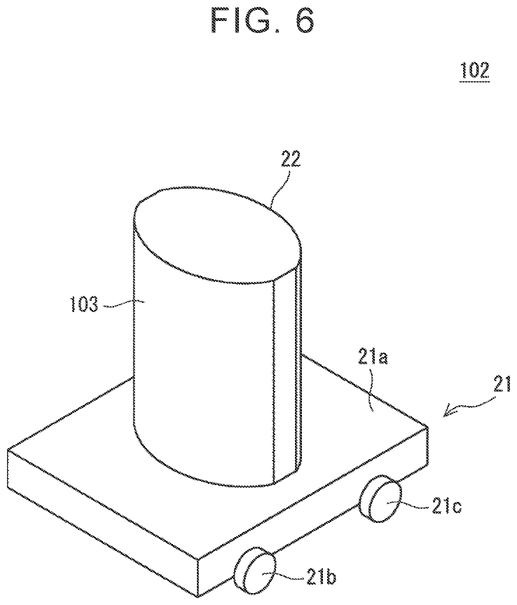

FIG. 4 is a block diagram showing a control system of a telepresence system according to an embodiment. FIG. 5 is a front perspective view showing a telepresence robot according to the embodiment. FIG. 6 is a rear perspective view showing the telepresence robot according to the embodiment.

Since a telepresence system 101 according to the embodiment has substantially the same configuration as the telepresence system 1 according to the first embodiment, duplicate description will be omitted, and the same elements will be denoted by the same reference signs.

The telepresence system 101 is different from the telepresence system 1 according to the first embodiment in that a telepresence robot 102 includes a second display unit 103 in addition to the display unit (first display unit) 22.

The second display unit 103 includes a display device such as a liquid crystal display or an organic EL display. The second display unit 103 displays a composite image of image information on the person P2 at the second base H2 and image information in a rear direction of the second display unit 103.

The second display unit 103 is fixed to the moving unit 21 so as to be able to display an image toward the rear of the telepresence robot 102. Therefore, a display surface of the second display unit 103 is disposed so as to face the rear of the telepresence robot 102.

The composition unit 105 of the image processing device 104 generates, as an image to be displayed on the first display unit 22 of the telepresence robot 102, a composite image by combining the extracted image information on the person P2 at the second base H2 and the image information in the rear direction of the first display unit 22, the image being captured by the background imaging unit 24,

Further, the composition unit 105 of the image processing device 104 generates, as an image to be displayed on the second display unit 103 of the telepresence robot 102, a composite image by combining the extracted image information on the person P2 at the second base H2 and the image information in the rear direction of the second display unit 103, the image being captured by the foreground imaging unit 23.

As a result, the first display unit 22 of the telepresence robot 102 can display a composite image of the extracted image information on the person P2 at the second base H2 and the image information in the rear direction of the first display unit 22, the image being captured by the background imaging unit 24.

Further, the second display unit 103 can display a composite image of the extracted image information on the person P2 at the second base H2 and the image information in the rear direction of the second display unit 103, the image being captured by the foreground imaging unit 23.

Therefore, the person P1 at the first base H1 can have a dialogue with the person P2 at the second base H2 not only from the front side of the telepresence robot 102 but also from the rear side thereof. For example, a plurality of persons can have a dialogue with the person P2 at the second base H2 from each of the front and rear sides of the telepresence robot 102.

Here, the display unit 6 at the second base H2 may display both the image captured by the foreground imaging unit 23 and the image captured by the background imaging unit 24, or may display only one of the images in which the person P1 at the first base H1 is displayed.

The second display unit 103 of the telepresence robot 102 according to the embodiment is disposed so as to display an image toward the rear of the telepresence robot 102, but the second display unit 103 may be disposed such that a direction in which the second display unit 103 displays the image is different from a direction in which the first display unit 22 displays the image.

Further, the telepresence robot 102 may include the foreground imaging unit 23 and the background imaging unit 24 for having a dialogue using the first display unit 22, and may include another foreground imaging unit and background imaging unit for having a dialogue using the second display unit 103.

### Third Embodiment

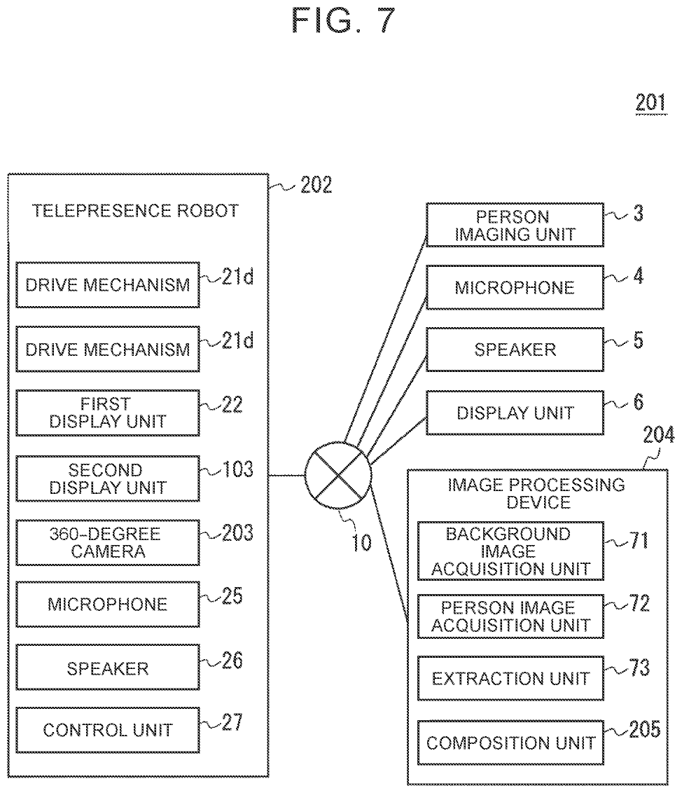

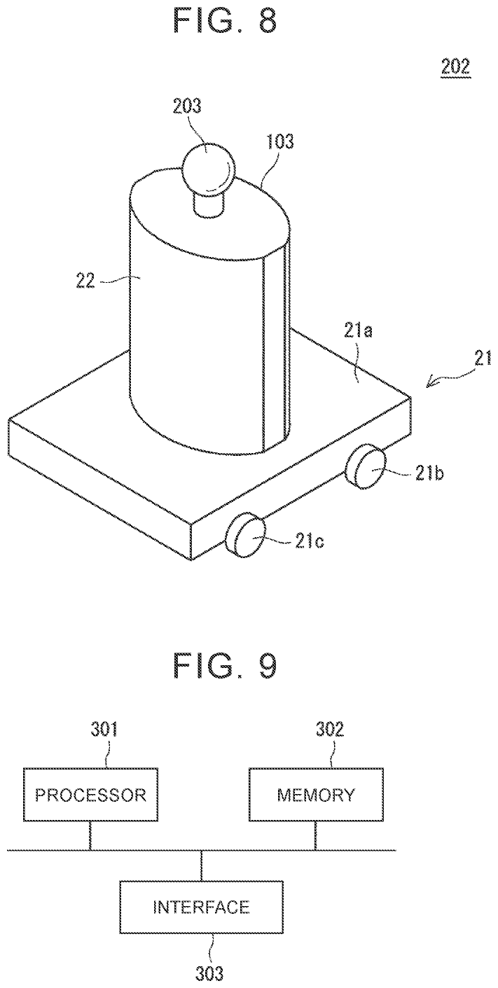

FIG. 7 is a block diagram showing a control system of a telepresence system according to an embodiment. FIG. 8 is a front perspective view showing a telepresence robot according to the embodiment. Since a telepresence system 201 according to the embodiment has substantially the same configuration as the telepresence system 101 according to the second embodiment, duplicate description will be omitted, and the same elements will be denoted by the same reference signs.

As shown in FIG. 7, the telepresence system 201 is different from the telepresence system 101 according to the second embodiment in that a telepresence robot 202 is provided with a 360-degree camera 203 in place of the foreground imaging unit 23 and the background imaging unit 24.

The 360-degree camera 203 is fixed to the upper end of the first display unit 22 and the second display unit 103, for example, as shown in FIG. 8. A general 360-degree camera can be used as the 360-degree camera 203, and for example, a dual-lens type 360-degree camera can be used.

As a result, image information on the entire area around the telepresence robot 202 can be acquired, and using the image information, the composition unit 205 of the image processing device 204 can generate, as an image to be displayed on the first display unit 22, a composite image by combining the extracted image information on the person P2 at the second base H2 and the image information in the rear direction of the first display unit 22, the image being captured by the 360-degree camera 203.

Further, the composition unit 205 of the image processing device 204 can generate, as an image to be displayed on the second display unit 103 of the telepresence robot 202, a composite image by combining the extracted image information on the person P2 at the second base H2 and the image information in the rear direction of the second display unit 103, the image being captured by the 360-degree camera 203.

In such a telepresence system 201, the number of imaging units can be reduced as compared with the telepresence system 101 according to the second embodiment, so that the telepresence system 201 can be configured at low cost.

### OTHER EMBODIMENTS

The image processing device according to the above embodiment can be provided with the following hardware configuration. FIG. 9 is a diagram showing an example of a hardware configuration included in an image processing device. In the various embodiments described above, as described in the processing procedure in the image processing device, the present disclosure may also take a form as an image processing method.

A device shown in FIG. 9 includes a processor 301 and a memory 302 together with an interface 303. A part of the configuration of the image processing device described in the above embodiments is realized by the processor 301 reading and executing a program stored in the memory 302. That is, this program is a program for causing the processor 301 to function as a part of the configuration of the image processing device. It can be said that this program is a program for causing the image processing device to execute processing in its configuration or a part thereof.

The programs described above are stored using various types of non-transitory computer readable media and can be supplied to a computer (a computer including an information notification device). The non-transitory computer-readable media include various types of tangible storage media. Examples of the non-transitory computer-readable media include magnetic recording media (e.g., flexible disks, magnetic tapes, hard disk drives), magneto-optical recording media (e.g., magneto-optical disks). Further, these examples include a compact disc read-only memory (CD-ROM), a compact disc recordable (CD-R), and a compact disc rewritable (CD-R/W). Further, these examples include semiconductor memories (e.g., mask read only memory (ROM), programmable read only memory (PROM), erasable programmable read only memory (EPROM), flash ROM, random access memory (RAM)). The program may also be supplied to a computer by various types of transitory computer-readable media. Examples of the transitory computer-readable media include electrical signals, optical signals, and electromagnetic waves. The transitory computer-readable media can supply the programs to a computer via a wired communication path such as an electric wire and an optical fiber, or a wireless communication path.

The present disclosure is not limited to the above embodiments, and can be appropriately modified without departing from the spirit.

What is claimed is:

1. An image processing device that processes an image to be displayed on a display unit of a telepresence robot disposed at a first base, the image processing device comprising:
a background image acquisition unit that acquires, in real time, image information obtained by capturing an image in a rear direction of the display unit;
a person image acquisition unit that acquires, in real time, image information including a person at a second base that is a remote area from the first base;
an extraction unit that extracts an area in which the person is displayed from the image information including the person; and
a composition unit that combines the extracted image information on the person and the image information in the rear direction of the display unit.

2. A telepresence system comprising:
the image processing device according to claim 1;
a person imaging unit that captures an area including a person at a second base;
a telepresence robot provided with a display unit; and
a background imaging unit that captures an image in a rear direction of the display unit.

3. The telepresence system according to claim 2, further comprising:
a first display unit as the display unit; and
a second display unit that displays an image in a direction different from a direction of the first display unit.

4. The telepresence system according to claim 3, further comprising:
a first imaging unit that captures an image in a rear direction of the first display unit as the background imaging unit; and
a second imaging unit that captures an image in a rear direction of the second display unit.

5. The telepresence system according to claim 3, further comprising a 360-degree camera as the background imaging unit.

6. An image processing method that processes an image to be displayed on a display unit of a telepresence robot disposed at a first base, the image processing method comprising:
a step of acquiring, in real time, image information obtained by capturing an image in a rear direction of the display unit;
a step of acquiring, in real time, image information including a person at a second base that is a remote area from the first base;
a step of extracting an area in which the person is displayed from the image information including the person; and
a step of combining the extracted image information on the person and the image information in the rear direction of the display unit.

7. An image processing program that processes an image to be displayed on a display unit of a telepresence robot disposed at a first base, the image processing program causing a computer to execute:
a process of acquiring, in real time, image information obtained by capturing an image in a rear direction of the display unit;
a process of acquiring, in real time, image information including a person at a second base that is a remote area from the first base;
a process of extracting an area in which the person is displayed from the image information including the person; and
a process of combining the extracted image information on the person and the image information in the rear direction of the display unit.
